(19) United States
(12) Patent Application Publication
(10) Pub. No.: US 2014/0150340 A1
(43) Pub. Date: Jun. 5, 2014

(54) Apparatus and Method for Transforming Bottles Into Grow Light Terrariums

(71) Applicant: Metin A. Gunsay, Bluffdale, UT (US)

(72) Inventor: Metin A. Gunsay, Bluffdale, UT (US)

(21) Appl. No.: 14/086,699

(22) Filed: Nov. 21, 2013

Related U.S. Application Data
(60) Provisional application No. 61/733,845, filed on Dec. 5, 2012.

(51) Int. Cl. A01G 7/04

(52) U.S. Cl. CPC A01G 7/045
USPC 47/69; 47/58.1 R

(57) ABSTRACT

The present invention is an apparatus, which makes it easier to implement bottle based terrariums using a grow light, by employing multiple side clip pairs, ideally shaped to interface with the curvature of the bottle, that join the upper and lower sides of a cut bottle, and a cable feeding mechanism that allows the grow light's height to be adjusted, while blocking moisture from dissipating through the mouth of the bottle, comprised of a slitted plug with a channel for the cable. The grow light also features control circuitry to set and adjust automatic lighting thresholds and methods to determine ambient lighting levels.

### CROSS-REFERENCES TO RELATED APPLICATIONS

This Application claims priority on prior filed U.S. Provisional Application No. 61/733,845, filed Dec. 5, 2012 and incorporates the same by reference herein in its entirety.

### FIELD OF THE INVENTION

The present invention relates to the field of gardening and more particularly relates to equipment and a system useful in converting a plastic bottle into an effective and attractive terrarium.

### BACKGROUND OF THE INVENTION

Indoor gardening of houseplants, culinary and medicinal herbs is a popular past time for many people. Traditionally people raise plants in plastic or ceramic pots. Potted plants tend to dry out quickly requiring frequent watering, and also indoor plants typically do not get enough light. To overcome the issue of drying out, terrariums can be used to keep in the moisture. To overcome the problem of not enough light, grow lights can be used.

Commercially purchased terrariums tend to be expensive. In actuality any transparent container can be used as terrarium. In particular, transparent 2 or 3 liter soda bottles make very good terrariums, as they are tall enough to hold a plant, watertight, made of plastic that is food safe, and essentially free given that most people throw them away after drinking their contents.

This invention seeks to improve upon bottle terrariums, making them easier to implement, and use. The biggest problem with using a bottle as a terrarium is in keeping the sides joined, after they have been cut in half. People most often employ tape. The problem with tape is that it looks bad, and it has to be removed before opening up the container to access the plant for watering or other maintenance.

Another approach to convert a bottle into a terrarium is to slit one side of the bottle so that it will fit into the other side. This reduces the overall height of the bottle, reducing the available growing space for the plant. In addition, it is very unstable, as the top lid will tend to fall off if slightly nudged. It is also aesthetically unapppealing.

As mentioned, ensuring that a plant gets enough light inside is the other big problem associated with raising houseplants. While grow lights, and in particular LED grow lights are common, a grow light specifically designed for a bottle terrarium is novel. The grow light must be small enough to fit in the bottle, must have a connector small enough to be able to be fed through the mouth of the bottle, and must have a mechanism for blocking the mouth, to prevent moisture escaping, yet allow the cord of the grow light to pass through.

One other difficulty with many grow lights is that they are left on even when there is sufficient light coming through a window. In this invention, a light sensor is included in the grow light so that the lights can be turned off when the ambient light surpasses a predefined threshold. To adjust this threshold one or more buttons are used.

The present invention represents a departure from the prior art in that addresses both the issues of combining the bottles through the use of clips, and creating a cable feeding mechanism for the mouth of the bottle that allows the grow light's height to be adjusted, while blocking moisture from dissipating through the mouth of the bottle.

Because the grow light will be in a humid environment, and may be occasionally splashed with water during watering intervals, the grow light should be water resistant. Rather than using mechanical buttons to adjust a lighting threshold, capacitive sensors may be used. These sensor buttons can be used to incrementally adjust a light threshold used to activate the grow light, or they can be used to take a “snapshot” of a given ambient light to set such a threshold.

It is also difficult to power grow lights especially multiple distinct small LED grow lights because of differences in international standards for power cord connectors, and because multiple cords, take up a limited number of power sockets. To overcome this problem, the grow light uses a USB cable and connector. Since USB is an international standard, the light can be powered in country, and because it can be conveniently plugged into any multiport USB hub, it is easy to power multiple lights with a single source.

### SUMMARY OF THE INVENTION

In view of the foregoing disadvantages inherent in the known types of bottle terrariums, this invention provides a novel kit developed to create more efficient and stable terrariums while maintaining a pleasing aesthetic.

To accomplish these objectives, the kit comprises side clips that join the upper and lower sides of a cut bottle, and a cable feeding mechanism that allows the grow light's height to be adjusted, while blocking moisture from dissipating through the mouth of the bottle.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of one embodiment of the invention.

FIG. 2 is a perspective view of a pair of bottle clips for use with the present invention.

FIG. 3 is a top plan view of the pair of bottle clips shown in FIG. 2.

FIG. 4 is a perspective view of a slitted bottle plug for use with the present invention.

FIG. 5 is a perspective view of an LED grow light for use with the present invention.

FIG. 6 is a circuit block diagram of the LED grow light of FIG. 4.

### DRAWINGS—REFERENCE NUMERALS

10—Bottle

12—Outer Clip

12a—Clip Hook

12b—Outer Clip Inner Surface

14—Inner Clip

14a—Clip Slot

14b—Inner Clip Outer Surface

16—Clip Pair

18—Slitted Plug

18a—Plug Channel

20—Grow Light

22—Grow Light Cable

24—USB connector

26—Grow Light Enclosure

28—PCB

30—Capacitive Touch Sensors

32—LEDs

34—Light Sensor

36—Microcontroller

### DETAILED DESCRIPTION OF THE PREFERRED EMBODIMENT

With reference now to the drawings, the preferred embodiment of the terrarium assembly kit is herein described. It should be noted that the articles “a”, “an”, and “the”, as used in this specification, include plural referents unless the content clearly dictates otherwise.

A diagram of the preferred embodiment is described in FIG. 1. A bottle 10 is split into two halves, creating two cylindrical terrarium halves with similar diameter, so that the inside is accessible to inserting soil and plants. Multiple sets of bottle clips 16 are inserted into small holes which have been pierced or drilled into the bottle, around the perimeter of the bottle.

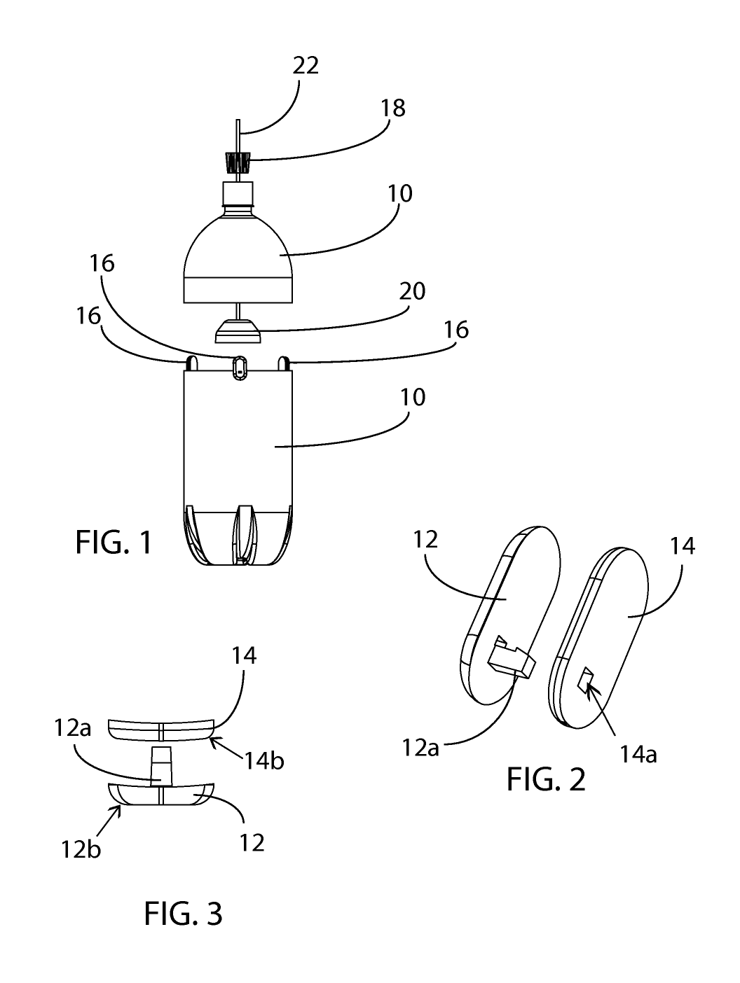

A bottle clip pair 16, as shown in FIG. 2, consists of an outer clip 12, and an inner clip 14. The outer clip has a male hook 12a which inserts and latches into the slot 14a in the inner clip 14. Note that the position of the hook and the slot could be reversed on the two clips. The outer clip 12 has an internal curvature 12b (FIG. 3) with a radius approximately equal the radius of the bottle so that it mounts flush to the outside of the bottle. This also keeps the clip aligned and prevents it from rotating. Likewise the inner clip 14 has a similar curvature 14b so that it mounts flush to the inside of the bottle. The hook keeps two clips joined. The clips are separated by a gap equal the thickness of the bottle material. This gap presents a slot so that the top of the bottle half can be inserted into the slot. Typically 3 or more clips are used so that the top rests with stability onto the base of the bottle.

It should be noted that alternatively to using a hook and slot to secure the clips, the clips could be directly glued onto the surface of the bottle, or alternatively they could have a sticky adhesive surface which allows them to be directly adhered to the bottle.

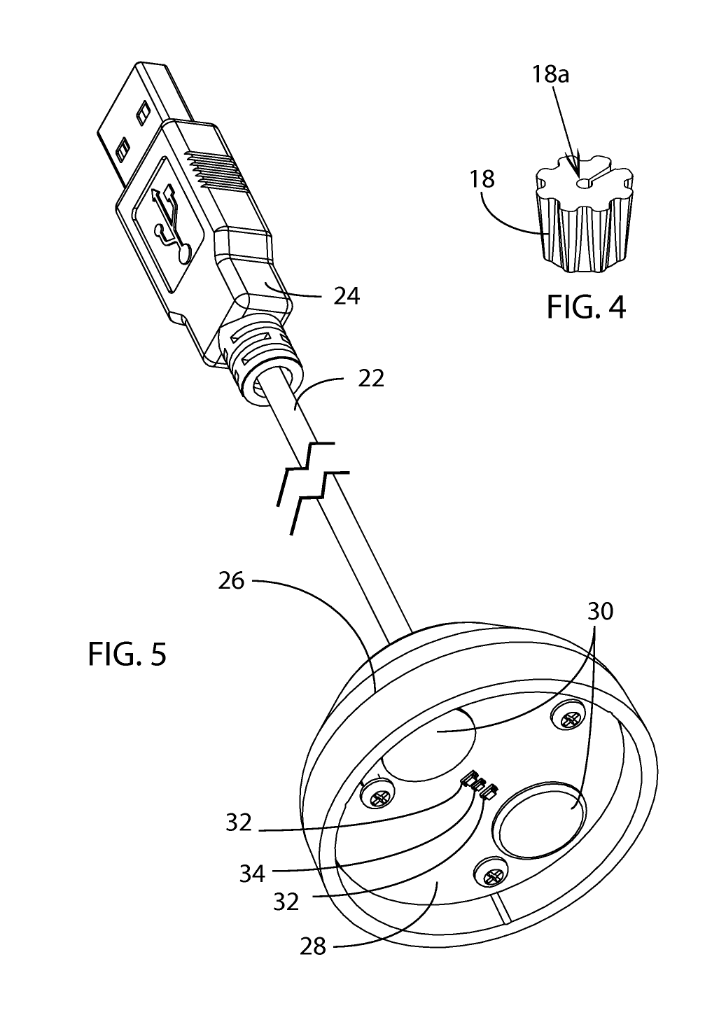

A slitted plug 18 acts as a feeding mechanism for a grow light's 20 power cable. As shown in FIG. 4, the plug has an axial channel 18a with diameter equal to the diameter of the power cable from which the slit extends until it intersects the perimeter of the plug 18. The plug provides an adjustable feeding mechanism for the grow light, and also plugs the mouth of the bottle to prevent moisture loss from the bottle terrarium. To adjust the height of the grow light, the cable is either pushed down into the plug or pulled upward. The plug may be made from a number of materials, but is typically made of a rubber-like material so that it fits snugly into the mouth of the bottle, and hugs the grow light cable securely. The grow light is ideally an LED that may be connected to a computer or other device with a central processing unit, such as by a USB connection, however any light source sufficiently small enough to fit inside the terrarium and also have an end capable of being threaded through the neck of the bottle will suffice.

In FIG. 5, the grow light is powered with a cable 22 through a USB—A type connector 24. A light sensor 34 monitors the ambient light levels to see if the light level is above a predefined threshold with hysteresis. If the light level is above the threshold, then the light will turn off or stay off. Likewise if the light level is below, the light will turn on or stay on. At least one Light Emitting Diode 32 provides the luminescence for the grow light.

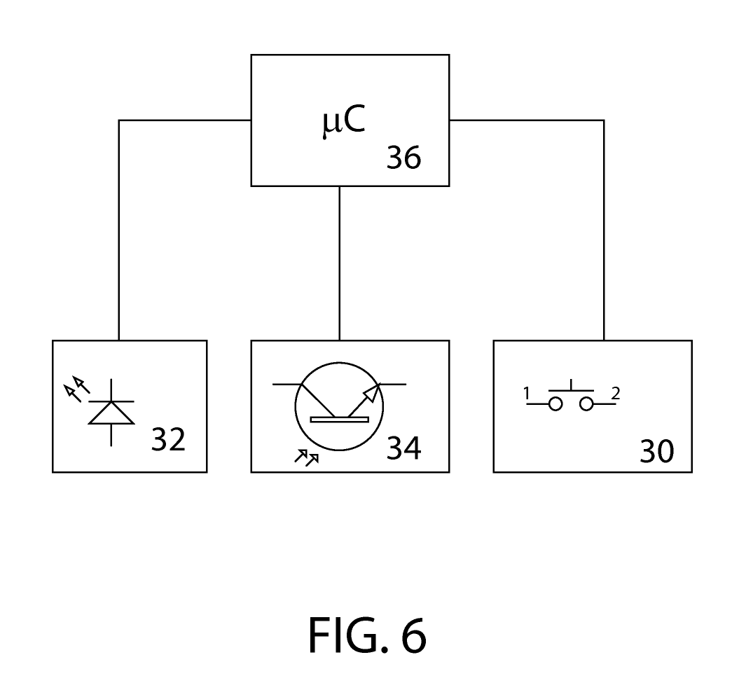

In FIG. 6 a microcontroller 36 with an internal analog to digital controller (ADC) samples the ambient light level, and compares the value to the predefined threshold stored in its internal memory, and turns on the LEDs 32. Because the light sensor 34 is proximate to the LEDs 32 it is difficult for the sensor 34 to measure the ambient light when the LEDs 32 are turned on. Thus, if the grow light LEDs 32 are turned on before the microcontroller 36 samples the ambient light level, it briefly turns the LEDs 34 off, and then turns them back on immediately after taking the sample. This can be done in a few microseconds (less than 100 μs being ideal), and so there is no humanly perceptible flicker of the light. The sampling can be done at any convenient interval such as once every second, minute, our, etc.

The light level threshold can be factory programmed, or adjustable by buttons. In FIG. 4, capacitive touch sensor buttons 30 are used to change the threshold. There are several methods to do this. For example, the buttons can be used to incrementally adjust the threshold, or the buttons can be used to trigger a snapshot of the current ambient light level, and this light level can be saved as the new light level threshold. The microcontroller controls the adjustment of the threshold, by monitoring the buttons for changes, monitoring the ambient light level, and then saving the new threshold into memory.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A terrarium assembly kit for use with two roughly cylindrical terrarium halves with similar diameter and corresponding edges, a top half having a narrow opening opposite its corresponding edge, the kit comprising:
a. at least one joining clip;
b. a stopper sized to fit in the narrow opening, the stopper further comprising an axial channel and a slit extending therefrom to a perimeter of the stopper; and
c. a light source operatively attached to a cable, the cable having a diameter such that the cable may be inserted into the axial channel;
wherein the two terrarium halves are joined by placing the corresponding edges inside the at least one joining clips and the terrarium is sealed by placing the stopper inside the narrow opening of the top half with the cable positioned in the axial channel in a manner to leave the light source inside the terrarium.

2. The terrarium assembly kit of claim 1, the at least one joining clip further comprising two discrete clip halves physically coupled together.

3. The terrarium assembly kit of claim 2, the at least one joining clip further comprising a male half and a female half that are joined together through a wall of one of the terrarium halves.

4. The terrarium assembly kit of claim 2, at least one of the male and female halves of the clip having a curvature in a surface approximate a curvature of the cylindrical terrarium halves.

5. The terrarium assembly kit of claim 1, the light source having an interface to allow control by a central processing unit.

6. The terrarium assembly kit of claim 1, the light source comprising a USB interface and connector.

7. The terrarium assembly kit of claim 1, the light source being an LED light source.

8. The terrarium assembly kit of claim 7, the LED light source comprising a light sensor and a microcontroller, enabling the light to be turned on and off at predetermined light level thresholds.

9. The terrarium assembly kit of claim 8, the LED light source further comprising at least one adjustment control, thereby allowing the predetermined light level thresholds to be adjusted.

10. The terrarium assembly kit of claim 9, the at least one adjustment control being at least one capacitive touch sensor button.

11. A method of determining ambient light levels about a terrarium grow light, the grow light comprising a light source, a light sensor proximate the light source and a microcontroller, the method comprising:
a. the microcontroller turning off the light source for a period of time less than one second;
b. the light sensor then sampling the ambient light levels;
c. said light levels being recorded; and
d. the microcontroller turning the light source on.

12. The method of claim 11, the period of time being less than 100 μs.
